(19) United States
(12) Patent Application Publication
(10) Pub. No.: US 2025/0299643 A1
(43) Pub. Date: Sep. 25, 2025

(54) METHODS AND SYSTEMS FOR MANAGING REMNANT VOLTAGE DURING FAST UPDATES IN ELECTROPHORETIC DISPLAYS

(71) Applicant: E INK CORPORATION, Billerica, MA (US)

(72) Inventors: Sanket DIWALE, Boston, MA (US); Amit DELIWALA, Andover, MA (US)

(21) Appl. No.: 19/078,697

(22) Filed: Mar. 13, 2025

Related U.S. Application Data
(60) Provisional application No. 63/567,299, filed on Mar. 19, 2024.

(51) Int. Cl. G09G 3/34; G02F 1/167; G02F 1/16766; G02F 1/1677

(52) U.S. Cl. CPC G09G 3/3446; G02F 1/167; G02F 1/16766; G02F 1/1677; G09G 2310/061; G09G 2320/0242

(57) ABSTRACT

Methods for actively managing remnant voltage on backplane electrodes when driving an electrophoretic display, especially with short waveforms, such as used for scrolling, pinch-zoom, pulldown menus, and even video. The methods track the remnant voltage changes for each backplane electrode during a series of image updates and use same color transitions to either improve the optical quality state of the display pixel or to decrease the remnant voltage at the display pixel. Thus, it is not necessary to employ full reset pulses, which typically drive a backplane electrode to both extreme voltage states and appear very “flashy” to a user.

### RELATED APPLICATIONS

This application claims priority to U.S. Provisional Application No. 63/567,299, filed Mar. 19, 2024. All patents and publications disclosed herein are incorporated by reference in their entireties.

### BACKGROUND

An electrophoretic display (EPD) changes color by modifying the position of a charged colored particle with respect to a light-transmissive viewing surface. Such electrophoretic displays are typically referred to as “electronic paper” or “ePaper” because the resulting display has high contrast and is sunlight-readable, much like ink on paper. In the simplest sense, an electrophoretic display only requires a light-transmissive electrode at the viewing surface, a back electrode, and an electrophoretic medium including one or more types of charged colored particles. If the back electrode includes controllable regions (pixels)—either segmented electrodes or an active matrix of pixel electrodes controlled by transistors—a pattern can be made to appear electronically at the viewing surface. The pattern can be, for example, the text to a book.

A variety of color options have become commercially available for electrophoretic displays, including four-color displays (black, white, red, yellow; red, white, yellow, semi-transparent blue; cyan, yellow, magenta, white). Electrophoretic displays with four types of electrophoretic particles operate similar to the simple black and white displays EPDs when, for example, a single color matching the color of one of the particles is desired at the viewing surface. However, obtaining a broader color gamut, including mixed colors and process colors is more complicated and requires more exquisite control of the relative positions of the particles with respect to each other and the viewing surface. When done correctly, such four particle systems allow hundreds of different colors to be produced at each pixel. More details of such systems are available in the following U.S. Patents, all of which are incorporated by reference in their entireties: U.S. Pat. Nos. 9,361,836, 9,921,451, 10,276,109, 10,353,266, 10,467,984, and 10,593,272.

Color electrophoretic displays can also be achieved using color filters arrays (CFA) disposed above or below a layer of electrophoretic display materials, for example a layer of microcapsules with black and white oppositely-charged particles that change position relative to a viewer due to a provided electric field. See, e.g., U.S. Pat. Nos. 8,098,418 and 10,444,592. However, electrophoretic displays incorporating CFAs suffer from loss of color spatial resolution due to subpixels. Traditionally, CFA displays have red, green, and blue filters, however other complimentary sets of colors can be used. Because of the subpixels, if one of the primary colors is to be shown for a pixel of the display, the pixel has only one third or less (less because there is filling between subpixels) of the display area to be utilized for showing that color. The other subpixels are dark to increase the chromaticity of the desired color.

Of course, most color images require more than red, green, blue, black, and white pixels. While it is possible to approximate some colors (e.g., purple) with mixes of subpixels, a more common method is to dither the colors across the pixels in an image to achieve the desired color and shading. However, when dithering is used to increase the available colors in an electrophoretic display, the dithered subpixels involved in the dithering process may be subject to unwanted cross-talk with nearby subpixels, which can result in dithered colors looking “off”. See, e.g., U.S. Pat. No. 11,869,451. Additional problems arise when, e.g., only part of the image is updated (a.k.a. partial update), which can also result in colors on the non-updated edges on the border of the updated pixels looking “off.” See, e.g., U.S. Pat. No. 11,557,260.

For the most part, electrophoretic media, such as described above, are designed to be driven with low voltage square waves, such as produced by a driver circuit from a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

When the electrophoretic medium includes multiple types of particles with the same charge polarity but different charge magnitudes, the final position of a given set of particles (and the optical state) is typically controlled with a sequence of positive and negative voltage impulses. For example, all of the positive particles may be driven to the viewing surface and then a combination of negative and positive voltages serves to disaggregate the collection of positive particles and drive the unwanted positive particles away from the view surface so that only the desired particle sets are viewed. However, driving methods that require multiple positive and negative pulses often result in color transitions that are visibly jarring to a user, also known as “flashy updates.” It is possible to decrease the amount of flash by making the waveforms longer and using smaller voltage steps, however such waveforms are not suitable for applications such as page turning or stylus writing. In such applications, a user expects a nearly instantaneous response by the display and high contrast between first and second optical states. (See, e.g., U.S. Patent Publication No. 2022/0262323 for a description of long gradual waveforms.) Historically, it has been difficult to achieve a short, low flash, low latency color waveform for such multi-particle systems.

Electro-optic displays typically have a backplane provided with a plurality of pixel electrodes, each of which defines one pixel of the display. Each pixel electrode is typically disposed in a rectangular array of pixel electrodes and each pixel electrode is controlled with a thin-film transistor (TFT), and the TFTs are updated in a row-by-row fashion. Conventionally, a single common electrode extending over a large number of pixels, and normally the whole display is provided on the opposed side of the electro-optic medium. The individual pixel electrodes may be driven directly (i.e., a separate conductor may be provided to each pixel electrode) or the pixel electrodes may be driven in an active-matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore, depending upon the type of display, i.e., black/white, color, black/white with color filter, the results of the edge ghosting can range from annoying to debilitating. In some cases, asymmetric blooming may contribute to edge ghosting.

Much of the discussion below will focus on methods for driving one or more pixels of an electrophoretic display through a transition from an initial color state to a final color state (which may or may not be different from the initial color state). The term “waveform” will be used to denote the entire voltage against time curve used to affect the transition from one specific first color state to a specific second color state. Typically, such a waveform will comprise a plurality of waveform elements; where these elements are essentially rectangular (V×t) voltage pulses (i.e., where a given element comprises application of a constant voltage for a period of time); the elements may be called “pulses” or “drive pulses”. The term “drive scheme” denotes a set of waveforms sufficient to affect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, to use more than one drive scheme simultaneously in different areas of the same display, and a set of drive schemes used in this manner may be referred to as “a set of simultaneous drive schemes.”

Whether or not the electro-optic medium used is bistable, to obtain a high-resolution display, individual pixels of a display must be addressable with minimum interference from adjacent pixels. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again the assignment of sources to rows and gates to columns is conventional but essentially arbitrary, and could be reversed if desired. The row electrodes are connected to a row driver, which essentially ensures that at any given moment only one row is selected, i.e., that there is applied to the selected row electrode a voltage such as to ensure that all the transistors in the selected row are conductive, while there is applied to all other rows a voltage such as to ensure that all the transistors in these non-selected rows remain non-conductive. The column electrodes are connected to column drivers, which place upon the various column electrodes voltages selected to drive the pixels in the selected row to their desired optical states. (The voltages are relative to a common front electrode which is conventionally provided on the opposed side of the electro-optic medium from the non-linear array and extends across the whole display.) After a pre-selected interval known as the “line address time” the selected row is deselected, the next row is selected, and the voltages on the column drivers are changed so that the next line of the display is written. This process is repeated so that the entire display is written in a row-by-row manner.

It might at first appear that the ideal method for addressing such an impulse-driven electro-optic display would be so-called “general grayscale image flow” in which a controller arranges each writing of an image so that each pixel transitions directly from its initial gray level to its final gray level. However, inevitably there is some error in writing images on an impulse-driven display. Some such errors encountered in practice include:
(a) Prior State Dependence; With at least some electro-optic media, the impulse required to switch a pixel to a new optical state depends not only on the current and desired optical state, but also on the previous optical states of the pixel.
(b) Dwell Time Dependence; With at least some electro-optic media, the impulse required to switch a pixel to a new optical state depends on the time that the pixel has spent in its various optical states. The precise nature of this dependence is not well understood, but in general, more impulse is required the longer the pixel has been in its current optical state.
(c) Temperature Dependence; The impulse required to switch a pixel to a new optical state depends heavily on temperature.
(d) Humidity Dependence; The impulse required to switch a pixel to a new optical state depends, with at least some types of electro-optic media, on the ambient humidity.
(e) Mechanical Uniformity; The impulse required to switch a pixel to a new optical state may be affected by mechanical variations in the display, for example variations in the thickness of an electro-optic medium or an associated lamination adhesive. Other types of mechanical non-uniformity may arise from inevitable variations between different manufacturing batches of medium, manufacturing tolerances and materials variations.
(f) Voltage Errors; The actual impulse applied to a pixel will inevitably differ slightly from that theoretically applied because of unavoidable slight errors in the voltages delivered by drivers.

In general, complex electrophoretic displays suffer from an “accumulation of errors” phenomenon. For example, imagine that temperature dependence results in a 0.2 L* (where L* has the usual CIE definition:

$${L}^{*} = 116 {( R / {R}_{0} )}^{1 / 3} - 16 ,$$

where R is the reflectance and R₀ is a standard reflectance value) error in the positive direction on each transition. After fifty transitions, this error will accumulate to 10 L*. Perhaps more realistically, suppose that the average error on each transition, expressed in terms of the difference between the theoretical and the actual reflectance of the display is +0.2 L*. After 100 successive transitions, the pixels will display an average deviation from their expected state of 2 L*; such deviations are apparent to the average observer on certain types of images. The same principles carry over for color electrophoretic displays, however the accumulation of errors may be in the a* or b* direction of the CIELAB color space, or some combination of L*, a*, and b*.

This accumulation of errors phenomenon applies not only to errors due to temperature, but also to errors of all the types listed above. Compensating for such errors is possible, but only to a limited degree of precision, depending upon the application, the desired performance, and the available processing power. For example, temperature errors can be (easily) compensated by using a temperature sensor and a lookup table, but the temperature sensor has a limited resolution and may read a temperature slightly different from that of the electro-optic medium. To some degree, prior state dependence can be compensated by storing the prior states and using a multi-dimensional transition matrix, but controller memory limits the number of states that can be recorded and the size of the transition matrix that can be stored, placing a limit on the precision of this type of compensation. For advanced applications, it may not be possible to complete the calculations fast enough at the controller level, thus requiring compensation for the accumulation of errors to be done at the processor level. See, e.g., U.S. Pat. No. 10,672,350 (incorporated by reference in its entirety) where prior state considerations of optical state, remnant voltage, and grey level drift are completed simultaneously.

There is additionally a desire to drive electrophoretic displays at ever faster rates, even sufficient to allow video viewing. Waveform design for a fast optical response requires achieving a given optical state using the shortest possible waveform but also introduces another pathway for optical state errors and remnant voltage build up. Designing such short waveforms is challenging and sometimes impossible below a certain timing threshold due to limitations of the electrophoretic system itself. As the waveforms are made shorter, the observed optical state error and history dependent optical errors increase significantly, making the performance unacceptable for normal applications. Most commercially available electrophoretic displays employ longer waveforms resulting in slower refresh rates for the displays, making them unsuitable for playing smooth animations or videos. Using short waveforms to increase the refresh rate results in accumulated optical state errors, which cause a drift of the optical state. In particular, repeated cycles of state changes using short waveforms results in noticeable color state drift, which causes afterimages or “ghosts”. Some manufacturers, such as ONYX BOOX, offer software or hardware buttons to allow a user to force a hard refresh on the entire screen to remove ghosting.

Repeated short driving also introduces remnant voltage buildup because short drive waveforms may not be DC balanced (waveform impulses=time×voltage; DC balanced=impulses integrate to zero), or DC-balanced waveforms may be interrupted. Accordingly, consideration is needed to provide safe boundaries for remnant voltage build-up (voltage resulting from charge stored in the electrophoretic system) after application of a sequence of waveforms. An unbounded build-up of remnant voltage can permanently damage the display and in less catastrophic failures can lead to an undesired change in the optical state of the display. Previous attempts to compensate for the aggregated remnant voltage include impulse banking of the type described in U.S. Pat. No. 10,672,350. Nonetheless, impulse banking of the type described in the '350 patent does not proactively compensate for remnant voltage with each image update. Accordingly, a display may only undergo six to ten image updates before requiring clearing reset pulses or active remnant voltage discharge. When updating images at a high speed, such as 10 image frames per second or faster, there is insufficient time for clearing pulses without making at least some of the image transitions “flashy.”

The terms bistable and bistability are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called multi-stable rather than bistable, although for convenience the term bistable may be used herein to cover both bistable and multi-stable displays. While the bistable nature of electrophoretic displays allows for massive power savings over traditional “always on” displays such as LCD and LED, the bistability can lead to image retention between updates, a.k.a. “ghosts”.

The term impulse, when used to refer to driving an electrophoretic display, is used herein to refer to the integral of the applied voltage with respect to time during the period in which the display is driven. The term waveform, when used to refer to driving an electrophoretic display, is used to describe a series or pattern of voltages provided to an electrophoretic medium over a given time period (seconds, frames, etc.) to produce a desired optical effect in the electrophoretic medium.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,052,571 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation color adjustment; see for example U.S. Pat. Nos. 7,075,502; 7,839,564; and 9,812,073;
(h) Methods for driving displays; see for example U.S. Pat. Nos. 7,012,600; 7,453,445; and 9,792,862;
(i) Applications of displays; see for example U.S. Pat. Nos. 7,312,784 and 8,009,348; and
(j) Non-electrophoretic displays, as described in U.S. Pat. No. 6,241,921; and U.S. Patent Applications Publication No. 2015/0277160; and U.S. Patent Application Publications No. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449.

Although electrophoretic media are often opaque (since, for example, in many electrophoretic media, the particles substantially block transmission of visible light through the display) and operate in a reflective mode, many electrophoretic displays can be made to operate in a so-called shutter mode in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively. Additionally, as described in US Patent Application Publication No. 2021/0132459, encapsulated electrophoretic media can be incorporated into non-planar surfaces that are, in turn, incorporated into everyday objects. As a result, surfaces of products, building materials, etc. can be engineered to change color when a suitable electric field is supplied.

### SUMMARY

Disclosed herein are methods for improved remnant voltage management during fast updates in an electrophoretic display. The methods of the invention result in less color drift during fast updates (i.e., A2), allow for interruptible updates, and reduce the risk of damage to the display when driven at high speed, i.e., to view videos. In a first aspect, a method for regulating remnant voltage in an electrophoretic display comprising a layer of electrophoretic media disposed between a light-transmissive electrode and a plurality of drive electrodes and a controller coupled to the plurality of drive electrodes. The method includes determining for each display pixel in the electrophoretic display whether that display pixel has a same color state for a first image and a second image, sending instructions to the controller to provide waveforms corresponding to a transition from the color state of the first image to the color state of the second image for each display pixel that does not have the same color state for the first image and the second image, determining a calculated remnant voltage for each display pixel having the same color state for the first image and the second image, determining a projected remnant voltage for each display pixel having the same color state for the first image and the second image when that display pixel receives instructions to increase optical quality state, comparing the projected remnant voltage for each display pixel having the same color state for the first image and the second image to a remnant voltage threshold, sending instructions to the controller to provide waveforms causing an increase in optical quality state for each display pixel having the same color state for the first image and the second image and having a projected remnant voltage less than the remnant voltage threshold, and sending instructions to the controller to provide waveforms causing a decrease in remnant voltage for each display pixel having the same color state for the first image and the second image and having a projected remnant voltage greater than or equal to the remnant voltage threshold. In one embodiment, the method further includes comparing the calculated remnant voltage to the remnant voltage threshold and sending instructions to the controller to provide waveforms causing a clearing transition for each display pixel having a calculated remnant voltage greater than or equal to the remnant voltage threshold. In one embodiment, the determining and comparing steps are completed with a processor coupled to memory and the controller. In one embodiment, the memory comprises a look up table of waveforms indexed by color state transition and remnant voltage. In one embodiment, each display pixel corresponds to one of the plurality of drive electrodes. In one embodiment, the electrophoretic display comprises an electrophoretic medium including electrically charged particles dispersed in a fluid and confined within a plurality of capsules or microcells. In one embodiment, the electrophoretic medium includes four different types of electrically charged particles, and at least two of the types of electrically charged particles have opposite polarities. In one embodiment, six primary colors can be formed at each pixel electrode of the electrophoretic display. In one embodiment, the electrophoretic display includes a color filter array and each display pixel includes multiple drive electrodes. In one embodiment, the color filter array comprises a plurality of differently colored filters and individual differently colored filters are indexed to individual drive electrodes. In one embodiment, the waveforms causing an increase in optical quality state are tuned to reduce remnant voltage increase while increasing optical quality state. In one embodiment, the waveforms causing a decrease in remnant voltage are tuned to maintain the optical quality state. In one embodiment, the first image and the second image are displayed on the electrophoretic display within 100 ms, preferably within 50 ms. In one embodiment, the plurality of drive electrodes are arranged in an array of pixel electrodes and each pixel electrode is coupled to a thin-film transistor (TFT), the TFT preferably comprising a metal oxide semiconductor, most preferably IGZO.

In another aspect, an electrophoretic display configured to actively manage remnant voltage during updates. The electrophoretic display including a light-transmissive electrode, a plurality of drive electrodes, a layer of electrophoretic media disposed between the light-transmissive electrode and the plurality of drive electrodes, a controller coupled to the plurality of drive electrodes, and a processor. The processor is configured to determine for each display pixel in the electrophoretic display whether that display pixel has a same color state for a first image and a second image, send instructions to the controller to provide waveforms corresponding to a transition from the color state of the first image to the color state of the second image for each display pixel that does not have the same color state for the first image and the second image, determine a calculated remnant voltage for each display pixel having the same color state for the first image and the second image, determine a projected remnant voltage for each display pixel having the same color state for the first image and the second image when that display pixel receives instructions to increase optical quality state, compare the projected remnant voltage for each display pixel having the same color state for the first image and the second image to a remnant voltage threshold, send instructions to the controller to provide waveforms causing an increase in optical quality state for each display pixel having the same color state for the first image and the second image and having a projected remnant voltage less than the remnant voltage threshold, and send instructions to the controller to provide waveforms causing a decrease in remnant voltage for each display pixel having the same color state for the first image and the second image and having a projected remnant voltage greater than or equal to the remnant voltage threshold. In one embodiment, the processor is further configured to compare the calculated remnant voltage to the remnant voltage threshold and send instructions to the controller to provide waveforms causing a clearing transition for each display pixel having a calculated remnant voltage greater than or equal to the remnant voltage threshold. In one embodiment, the electrophoretic display further comprises memory including a look up table of waveforms indexed by color state transition and remnant voltage. In one embodiment, each display pixel corresponds to one of the plurality of drive electrodes. In one embodiment, the electrophoretic medium includes electrically charged particles dispersed in a fluid and confined within a plurality of capsules or microcells. In one embodiment, the electrophoretic medium includes four different types of electrically charged particles, and at least two of the types of electrically charged particles have opposite polarities. In one embodiment, six primary colors can be formed at each pixel electrode of the electrophoretic display. In one embodiment, the electrophoretic display includes a color filter array and each display pixel includes multiple drive electrodes. In one embodiment, the color filter array comprises a plurality of differently colored filters and individual differently colored filters are indexed to individual drive electrodes. In one embodiment, the waveforms causing an increase in optical quality state are tuned to reduce remnant voltage increase while increasing optical quality state. In one embodiment, the waveforms causing a decrease in remnant voltage are tuned to maintain the optical quality state. In one embodiment, the first image and the second image are displayed on the electrophoretic display within 100 ms, preferably within 50 ms. In one embodiment, the plurality of drive electrodes are arranged in an array of pixel electrodes and each pixel electrode is coupled to a thin-film transistor (TFT), the TFT preferably comprising a metal oxide semiconductor, most preferably IGZO.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1A is a representative cross-section of a four-particle electrophoretic display wherein the electrophoretic medium is encapsulated in microcapsules.

FIG. 1B is a representative cross-section of a four-particle electrophoretic display wherein the electrophoretic medium is encapsulated in microcells.

FIG. 1C is a representative cross-section of an electrophoretic display, e.g., including an electrophoretic layer of oppositely charged black and white particles, coupled to a color filter array (CFA) disposed between the electrophoretic layer and the viewer.

FIG. 2A illustrates an exemplary equivalent circuit of a single pixel of an electrophoretic display that uses an active-matrix backplane with a storage capacitor.

FIG. 2B illustrates an exemplary equivalent circuit of a simplified electrophoretic display of the invention, allowing driving in a row-column format.

FIG. 3 illustrates an exemplary electrophoretic display that includes a display module. The electrophoretic display also includes a processor, memory, one or more power supplies, and a controller. The electrophoretic display may also include sensors to allow the electrophoretic display to adjust operational parameters based upon the ambient environment, e.g., temperature and illumination.

FIG. 4A illustrates the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 4B illustrates the preferred position of each of the four sets of particles to produce seven standard colors in a white-red-yellow-blue semi-absorptive (WRYB*) four-particle electrophoretic display, wherein the white, red, and yellow particles are reflective and the blue particle is semi-absorptive (B*).

FIG. 5 is a flow chart showing an embodiment of the invention to actively control remnant voltage during a fast updates in an electrophoretic display.

FIG. 6 shows an exemplary Remnant Volage Dependent Render suitable to compute a remnant voltage penalty for accessing the next improved optical state. The next improved optical state and the resulting remnant voltage (current remnant voltage+penalty) are used to look up the needed waveform from a lookup table and pass the identified waveform to the controller.

FIG. 7 shows an exemplary color quality and remnant voltage map for an A2 (pseudo-two bit) fast drive scheme from black (K) to white (W). Similar color quality and remnant voltage maps can be created for other fast color transitions and the same techniques can be expanded to create a multi-dimensional map of color quality and remnant voltage transitions.

FIG. 8 illustrates the consistency in the resulting color state for an alternating A2 speed black-to-white transition in a white-cyan-magenta-yellow (WCMY) four-particle system when using the methods of the invention.

FIG. 9 shows the resulting color state and the remnant voltage build up for an alternating A2 speed black-to-white transition in a white-cyan-magenta-yellow (WCMY) four-particle system using conventional methods of A2 driving. Notably, the conventional methods result in a higher and less consistent b* value with repeated driving. This change in b* is perceived as yellowing. See also FIG. 12.

FIG. 10A shows tuned waveforms for white to black (upper right hand) and black to white (lower left hand) transitions for use with the invention. The waveforms of FIG. 10B are tuned to be shorter (5 frames versus 6) and to have an overall smaller impulse, resulting in a decreased penalty to remnant voltage while increasing the optical quality of a color state of a given pixel.

FIG. 10B illustrates optical quality improvement (“stomp”) waveforms to drive transitions to an improved black state (upper right hand) and to an improved white state (lower left hand).

FIG. 11 illustrates an alternating A2 speed black-to-white transition in a white-cyan-magenta-yellow (WCMY) four-particle system when using the methods of the invention and including tuned waveforms.

FIG. 12 shows stills from a video of a pinch-zoom test on a white-cyan-magenta-yellow (WCMY) four-particle system driven in A2 mode with conventional (top) remnant voltage management and with methods of the invention (bottom). It is evident that, using the methods of the invention, the final white state after two cycles of pinch-zoom is less yellow. The increased yellowing results from remnant voltage build up and typically requires a full-page refresh to clear.

### DETAILED DESCRIPTION

The invention details methods for actively managing remnant voltage on backplane electrodes when driving an electrophoretic display. The methods are especially useful for fast updates, such as scrolling, pinch-zoom, pulldown menus, and even video. The methods involve tracking the remnant voltage changes for each backplane electrode during a series of image updates and using so-called same color transitions to either improve the optical stage of the transition or to decrease the remnant voltage. Using these methods, it is not necessary to employ full reset pulses, which typically drive a backplane electrode to both extreme voltage states and appear very “flashy” to a user. Such methos are easily adapted into electrophoretic displays by including the methods of the invention in a processor that is coupled to the electrophoretic display. Using the methods of the invention, many of the color drift and ghosting problems can be diminished in color electrophoretic displays, regardless of the nature of the color electrophoretic display, be it multiple different-colored particles at each pixel electrode or a color filter array display including black and white particles beneath each subpixel of the display pixel.

Methods for fabricating an electrophoretic display including two, three, four (or more) particles have been discussed in the prior art. The electrophoretic fluid may be encapsulated in microcapsules or incorporated into microcell structures that are thereafter sealed with a polymeric layer. The microcapsule or microcell layers may be coated or laminated to a plastic substrate or film bearing a transparent coating of an electrically conductive material. Alternatively, the microcapsules may be coated onto a light transmissive substrate or other electrode material using spraying techniques. (See U.S. Pat. No. 9,835,925, incorporated by reference herein). The resulting assembly may be laminated to a backplane including pixel electrodes using an electrically conductive adhesive. The assembly may alternatively be attached to one or more segmented electrodes on a backplane, wherein the segmented electrodes are driven directly. In another embodiment the assembly, which may include a non-planar light transmissive electrode material is spray coated with capsules and then overcoated with a back electrode material. (See U.S. Patent Publication No. 2021/0132459, incorporated by reference herein.) Alternatively, the electrophoretic fluid may be dispensed directly on a thin open-cell grid that has been arranged on a backplane including an active matrix of pixel electrodes. The filled grid can then be top-sealed with an integrated protective sheet/light-transmissive electrode.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, typically a light-transmissive electrode, and the other electrode layer includes a plurality of driving electrodes, i.e., patterned into a matrix of pixel electrodes, each driving electrode defining one pixel of the display. In some embodiments, more than one drive electrode can be associated with one pixel of the display, especially in a color filter array (CFA) arrangement in which case each drive electrode is associated with a subpixel of a pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Electrophoretic media used herein include charged particles that vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. For example, the electrophoretic medium might include a fluid, a plurality of first and a plurality of second particles dispersed in the fluid, the first and second particles bearing charges of opposite polarity, the first particle being a light-scattering particle and the second particle having one of the subtractive primary colors, and a plurality of third and a plurality of fourth particles dispersed in the fluid, the third and fourth particles bearing charges of opposite polarity, the third and fourth particles each having a subtractive primary color different from each other and from the second particles, wherein the electric field required to separate an aggregate formed by the third and the fourth particles is greater than that required to separate an aggregate formed from any other two types of particles.

The electrophoretic media of the present invention may contain any of the additives used in prior art electrophoretic media as described for example in the E Ink and MIT patents and applications mentioned above. Thus, for example, the electrophoretic medium of the present invention will typically comprise at least one charge control agent to control the charge on the various particles, and the fluid may have dissolved or dispersed therein a polymer having a number average molecular weight in excess of about 20,000 and being essentially non-absorbing on the particles to improves the bistability of the display, as described in the aforementioned U.S. Pat. No. 7,170,670.

In one embodiment, the present invention uses a light-scattering particle, typically white, and three substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present invention may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, for example, the one-dimensional Kubelka-Munk treatment. In the present invention, it is preferred that the white pigment exhibit a diffuse reflectance at 550 nm, measured over a black background, of at least 5% when the pigment is approximately isotropically distributed at 15% by volume in a layer of thickness 1 μm comprising the pigment and a liquid of refractive index less than 1.55. The yellow, magenta and cyan pigments preferably exhibit diffuse reflectances at 650, 650 and 450 nm, respectively, measured over a black background, of less than 2.5% under the same conditions. (The wavelengths chosen above for measurement of the yellow, magenta and cyan pigments correspond to spectral regions of minimal absorption by these pigments.) Colored pigments meeting these criteria are hereinafter referred to as “non-scattering” or “substantially non-light-scattering”. Specific examples of suitable particles are disclosed in U.S. Pat. No. 9,921,451, which is incorporated by reference herein.

Alternative particle sets may also be used, including four sets of reflective particles, or one absorptive particle with three or four sets of different reflective particles, i.e., such as described in U.S. Pat. Nos. 9,922,603 and 10,032,419, which are incorporated by reference herein. For example, white particles may be formed from an inorganic pigment, such as TiO₂, ZrO₂, ZnO, Al₂O₃, Sb₂O₃, BaSO₄, PbSO₄ or the like, while black particles may be formed from CI pigment black 26 or 28 or the like (e.g., manganese ferrite black spinel or copper chromite black spinel) or carbon black. The third/fourth/fifth type of particles may be of a color such as red, green, blue, magenta, cyan or yellow. The pigments for this type of particles may include, but are not limited to, CI pigment PR 254, PR122, PR149, PG36, PG58, PG7, PB28, PB15:3, PY138, PY150, PY155 or PY20. Specific examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow.

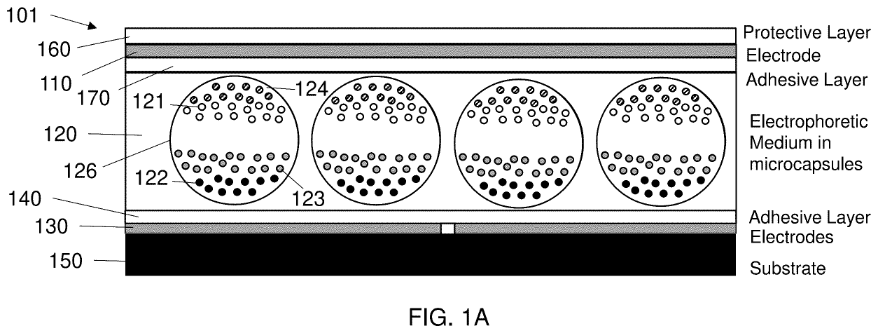

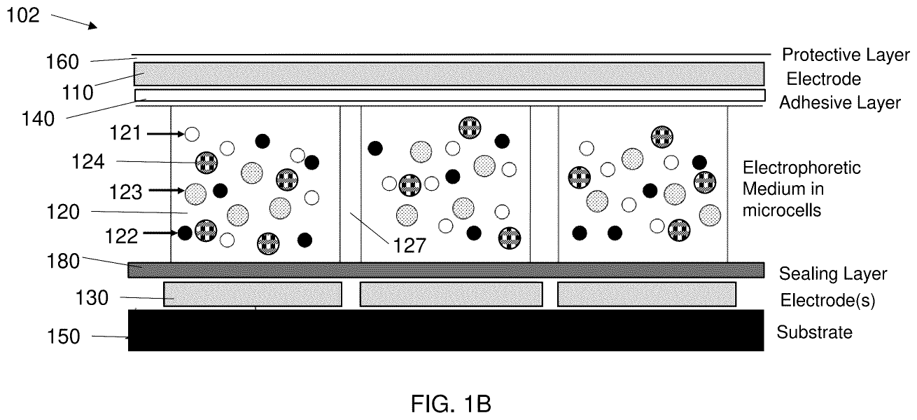

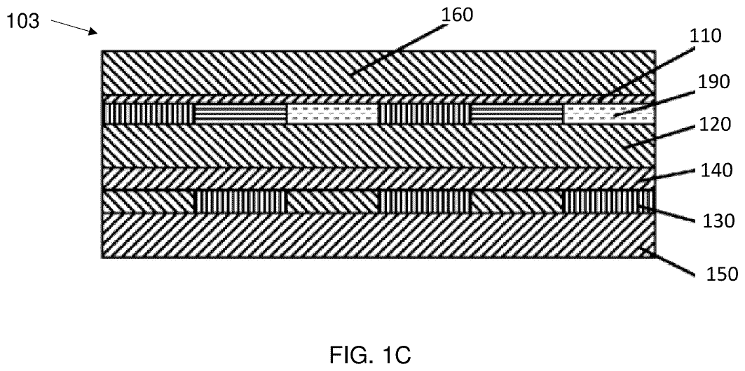

As shown in FIGS. 1A, 1B, and 1C, an electrophoretic display (101, 102, 103) typically includes a top transparent electrode 110, an electrophoretic medium 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. In the electrophoretic media 120 described in FIGS. 1A and 1B, there are four different types of particles, 121, 122, 123, and 124, however more particle sets can be used with the methods and displays described herein. In the CFA display 103, the electrophoretic medium 120 may include an encapsulated electrophoretic medium with only black and white oppositely charged particles. A CFA Display 103 typically includes color elements of red, green, and blue, e.g., a RBGW color filter array pattern. The colored elements may be provided directly the top transparent electrode 110, which may be, for example, indium-tin-oxide (ITO). Such CFA films are available from Toppan Printing (Japan). Alternatively, the color filter elements may be applied to the electrophoretic media 120 with an ink-jet or other precision printing process. See U.S. Pat. No. 10,209,556. In a common construction, each subpixel of the RGB CFA includes an independently controllable red, green, or blue subpixel with a portion around each subpixel being clear (a.k.a., partial fill CFA) in order to improve white and light colors in an image. Notably, the inclusion of a color filter decreases the display resolution because the number of image pixels is some fraction of the pixel electrodes on the backplane depending upon the color filter pattern. For example, for an RGB CFA, a backplane having 300 pixel electrodes per inch (PPI) has color pixel resolution of approximately 100 PPI.

In FIGS. 1A and 1B and similar embodiments, two of the four different types of particle sets, 121, 122, 123, and 124 are of first polarity, while the other two sets are of a second (opposite) polarity. In some embodiments, one of the four different types of particle sets, 121, 122, 123, and 124 is of first polarity, while the other three sets are of a second (opposite) polarity. In some embodiments two of the four different types of particle sets are of a first polarity, while the other two sets are of an opposite polarity. The electrophoretic medium 120 is typically compartmentalized by a microcapsule 126 or the walls of a microcell 127. An optional adhesive layer 140 can be disposed adjacent to any of the layers, however, it is typically adjacent an electrode layer (110 or 130). There may be more than one adhesive layer 140 in a given electrophoretic display (105, 106), however only one layer is more common. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include sealing layers 180 as needed. In some embodiments the adhesive layer 140 may include a primer component to improve adhesion to the electrode layer 110, or a separate primer layer (not shown in FIG. 1B) may be used. The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

In some embodiments, e.g., as shown in FIG. 1A, the electrophoretic display may include only a first light-transmissive electrode, an electrophoretic medium, and a second (rear) electrode, which may also be light-transmissive. However, to produce a high-resolution display, e.g., as shown in FIG. 1B. Of course, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary, and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode; again, the assignment of sources to rows and gates to columns is conventional but essentially arbitrary and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extend across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active-matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer framewidths are possible. For example, a frame can be 0.5 ms, or greater, such as 1 ms, 5 ms, 10 ms, 15 ms, 20 ms, 30 ms, or 50 ms. In most instances a frame is less than 100 ms, such 250 ms, 200 ms, 150 ms, or 100 ms. In most applications described herein, the frame is between 5 ms and 30 ms in width, for example 8 ms in width. Specialized drive controllers for electrophoretic displays are available from, e.g., Ultrachip and Rockchip, however programmable voltage drivers can also be used, such as available from Digi-Key and other electronics components suppliers.

In a conventional electrophoretic display using an active-matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to form the transistors and the “select” and “non-select” voltages applied to the gate electrodes can be positive and negative, respectively.

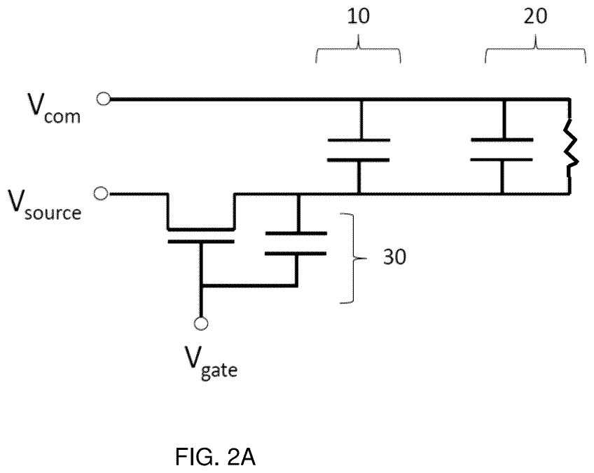

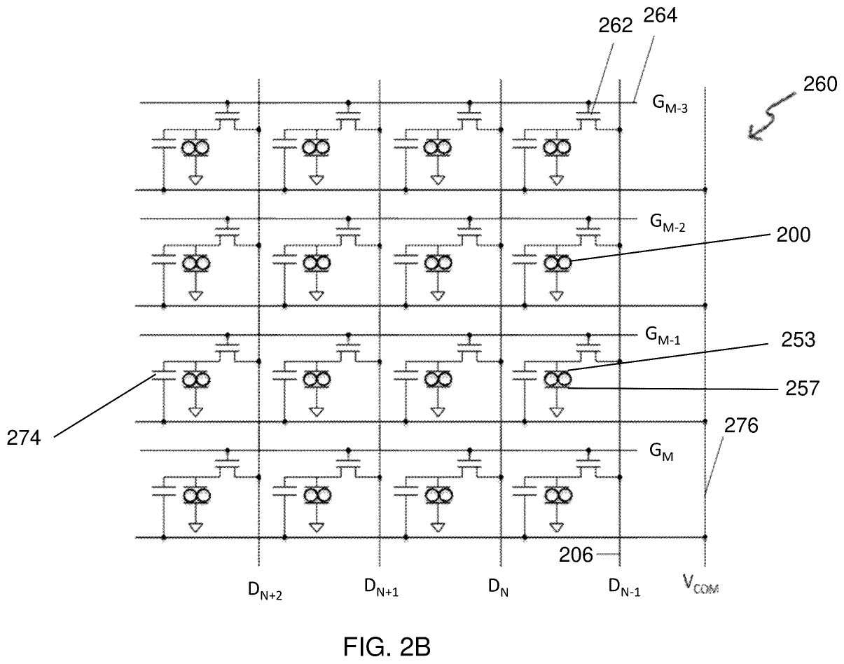

FIG. 2A of the accompanying drawings depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts. [In some embodiments, to compensate for the unwanted “kickback voltage”, a common potential V_{com}, may be supplied to the top plane electrode and the capacitor electrode associated with each pixel, such that, when V_{com} is set to a value equal to the kickback voltage (VKB), every voltage supplied to the display may be offset by the same amount, and no net DC-imbalance experienced.]

In many embodiments, the TFT array forms an active matrix 260 for image driving, as shown in FIG. 2B. For example, each pixel electrode 253 (corresponding to 130 in FIGS. 1A and 1B) is coupled to a thin-film transistor 262 patterned into an array and connected to gate (row) driver lines 264 and source (column) driver lines 206, running at right angles to the gate drive lines 264. Also, typically, the common (top) light-transparent electrode 257 (corresponding to 110 in FIGS. 1A and 1B) has the form of a single continuous electrode while the other electrode or electrode layer is patterned into a matrix of pixel electrodes 253, each of which defines one pixel of the display. Between the pixel electrode 253 and the common electrode 257, an electrophoretic medium 200 can be disposed. Any of the electrophoretic media described above may be used, and while FIG. 2B depicts the electrophoretic medium as contained in microcapsules, microcells, as shown in FIG. 1B, as also suitable. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. The gate scanning rate is typically ˜60-150 Hz. When the TFTs 262 are n-type, taking the gate-source voltage positive allows the source voltage to be shorted to the drain. Taking the gate negative with respect to the source causes the drain source current to drop and the drain effectively floats. Because the scan driver acts in a sequential fashion, there is typically some measurable delay in update time between the top and bottom row electrodes. It is understood that the assignment of “row” and “column” electrodes is somewhat arbitrary and that a TFT array could be fabricated with the roles of the row and column electrodes interchanged. Each pixel of the active matrix 260 also includes a storage capacitor 274 as discussed above with respect to FIG. 2A. Storage capacitors 274 are typically coupled to V_{com} line 276. In some embodiments the common light-transparent electrode 257 is coupled to ground, as shown in FIG. 2B. In other embodiments, the common light-transparent electrode 257 is also coupled to V_{com} line 276 (not shown in FIG. 2B).

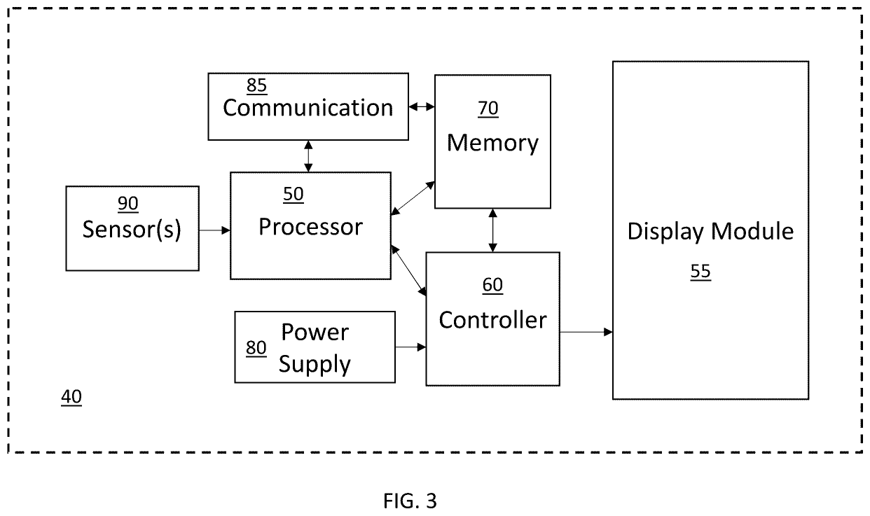

The active matrix 260 described with respect to FIG. 2B (i.e., including the electrophoretic medium 200 and the common light-transparent electrode 257) is typically covered by a protective sheet (e.g., integrated barrier) and sealed to create a display module 55, as shown in FIG. 3. Such a display module 55 becomes the focus of an electrophoretic display 40. The electrophoretic display 40 will typically include a processor 50, which is configured to coordinate the many functions relating to displaying content on the display module 55. The functions may include methods of the invention, i.e., coordinating remnant voltage management, waveform selection, and providing waveform instructions to the controller. The processor 50 (and associated memory) can also be used to transform “standard” images, such as sRGB images to a color regime that best duplicates the image on the display module 55. Depending upon the sophistication of controller 60, some of the steps of the invention may be completed by the controller 60. As controller 60 architecture advances, more of the remnant voltage management can be handled into the controller 60 such that an advanced controller can be incorporated into the same package as the display module 55 and pre-programmed with the tools needed to manage remnant voltage. Advanced controllers for electrophoretic displays are available from ULTRACHIP and NEXTRONIX.

The processor 50 is typically a mobile processor chip, such as made by Freescale or Qualcomm, although other manufacturers are known. Processor 50 is in frequent communication with the non-transitory memory 70, from which it pulls image files and look up tables (LUT) to perform the remnant voltage management during fast driving, as described below. The non-transitory memory 70 may also include gate driving instructions to the extent that a particular color transition may require a different gate driving pattern. The electrophoretic display 40 may have more than one non-transitory memory chip. The non-transitory memory 70 may be flash memory. Once the desired image has been converted for display on the display module 55, the specific image instructions are sent to a controller 60, which facilitates voltage sequences being sent to the respective thin film transistors (described above). Such voltages typically originate from one or more power supplies 80, which may include, e.g., a power management integrated chip (PMIC). The electrophoretic display 40 may additionally include communication 85, which may be, for example, WIFI protocols or BLUETOOTH, and allows the electrophoretic display 40 to receive images and instructions, which also may be stored in memory 70. The electrophoretic display 40 may additionally include one or more sensors 90, which may include a temperature sensor and/or a photo sensor, and such information can be fed to processor 50 to allow the processor to select an optimum look-up-table when such look-up-tables are indexed for ambient temperature or incident illumination intensity or spectrum. In some instances, multiple components of the electrophoretic display 40 can be embedded in a singular integrated circuit. For example, a specialized integrated circuit may fulfill the functions of processor 50 and controller 60.

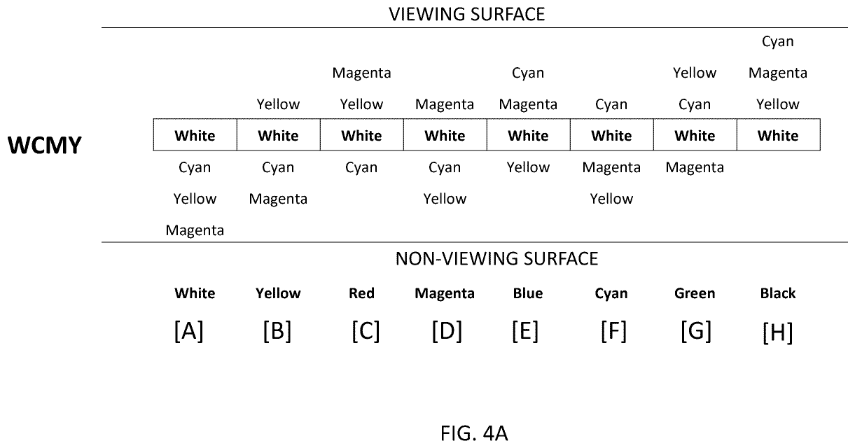

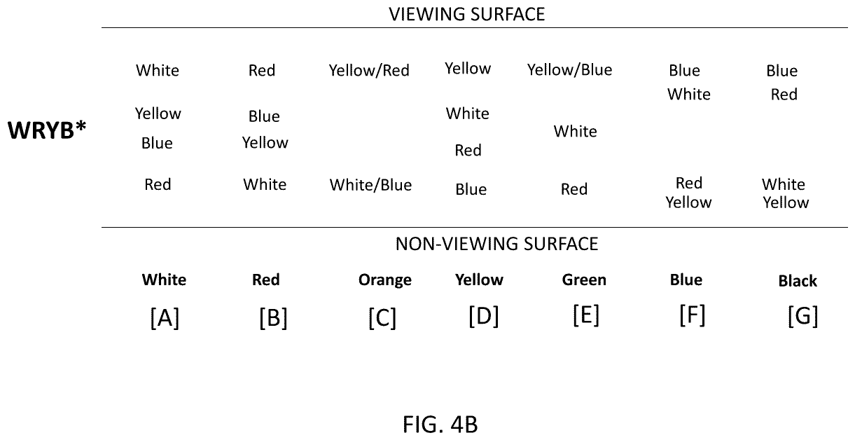

As shown in FIG. 4A, in the instance of a four-particle system including subtractive cyan, yellow, and magenta particles paired with a reflective white particle, each of the eight principal colors (red, green, blue, cyan magenta, yellow, black and white) corresponds to a different arrangement of the four pigments. The three particles providing the three subtractive primary colors, e.g., for an Advanced Color electronic Paper (ACeP) display, may be substantially non-light-scattering (“SNLS”). The use of SNLS particles allows mixing of colors and provides for more color outcomes than can be achieved with the same number of scattering particles. These thresholds must be sufficiently separated relative to the voltage driving levels for avoidance of crosstalk between particles, and this separation necessitates the use of high addressing voltages for some colors. In addition, addressing the colored particle with the highest threshold also moves all the other colored particles, and these other particles must subsequently be switched to their desired positions at lower voltages.

The system of FIG. 4A, in principle, works similar to printing on bright white paper in that the viewer only sees those colored pigments that are on the viewing side of the white pigment (i.e., the only pigment that scatters light). In FIG. 4A, it is assumed that the viewing surface of the display is at the top (as illustrated), i.e., a user views the display from this direction, and light is incident from this direction. As already noted, in preferred embodiments only one of the four particles used in the electrophoretic medium of the present invention substantially scatters light, and in FIG. 4A this particle is assumed to be the white pigment. This light-scattering white particle forms a white reflector against which any particles above the white particles (as illustrated in FIG. 4A) are viewed. Light entering the viewing surface of the display passes through these particles, is reflected from the white particles, passes back through these particles and emerges from the display. Thus, the particles above the white particles may absorb various colors and the color appearing to the user is that resulting from the combination of particles above the white particles. Any particles disposed below (behind from the user's point of view) the white particles are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 4A), there are no particles above the white particles and the pixel simply displays a white color. When a single particle is above the white particles, the color of that single particle is displayed, yellow, magenta and cyan in Situations [B], [D] and [F] respectively in FIG. 4A. When two particles lie above the white particles, the color displayed is a combination of those of these two particles; in FIG. 4A, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 4A), all the incoming light is absorbed by the three subtractive primary-colored particles and the pixel displays a black color. Because the order of the particles between the pixel electrode and viewer is critical, a pixel electrode that is not updated during a partial update can be disturbed by a neighboring pixel that is being updated. Furthermore, the resulting color shift may not be predictable because the highest charged particles, typically cyan, move the most due to inter-pixel coupling.

An alternative particle set using reflective color particles is shown in FIG. 4B. In the embodiment of FIG. 4B, the reflective particles are white, red, and yellow, and they are combined with a semi-transparent blue, however alternative color sets could be used provided that the combination of colors suitably span the useful color spectrum. In the system of FIG. 4B, for white, red, and yellow, the color viewed at the surface is due to direct reflection of the colored particles; for orange it is a mixture of red and yellow reflective pigments. For green, blue, and black at the viewing surface, the colors at the viewing surface are due to mixtures of the semi-transparent blue particles with reflective yellow, white, and red particles, respectively. Because a viewer is looking at light that is predominantly only interacting with one pigment surface, images produced with a system of FIG. 4B appear more saturated than the colors of FIG. 4A. However, the overall gamut of colors using a system of FIG. 4B is diminished as compared to those of FIG. 4A because it is difficult to achieve fine control of the number of specific particles that are mixed together to create secondary colors (e.g., orange, green, violet). In applications such as digital signage, the saturation is often more important than the color gamut, and many users are satisfied with a set of seven or eight “standard” colors. It should also be realized with respect to FIG. 4B, that the reflective red and semi-transparent blue particles can switch roles, i.e., to make an electrophoretic display medium including reflective white, yellow, and blue particles and a semi-transparent red particle. Such a system yields a set of primary colors similar to FIG. 4B, but wherein red at the viewing surface results from a combination of semi-transparent red and white. Because the system of FIG. 4B includes mostly reflective particles, electrophoretic displays including this medium are less influenced by inter-pixel coupling. However, the methods of the invention can still be used with these systems.

Different combinations of light scattering and light absorbing particle sets are also possible. For example, one subtractive primary color could be rendered by a particle that scatters light, so that the display would comprise two types of light-scattering particle, one of which would be white and another colored. In this case, however, the position of the light-scattering colored particle with respect to the other colored particles overlying the white particle would be important. For example, in rendering the color black (when all three colored particles lie over the white particles) the scattering, colored particle cannot lie over the non-scattering, colored particles (otherwise they will be partially or completely hidden behind the scattering particle and the color rendered will be that of the scattering, colored particle, not black). Of course, it would not be easy to render the color black if more than one type of colored particle scattered light without the presence of an absorptive black particle.

FIGS. 4A and 4B show idealized situations in which the colors are uncontaminated (i.e., the light-scattering white particles completely mask any particles lying behind the white particles in FIG. 4A, or the selected reflective particles shield all of the other particles that should not be visible in FIG. 4B). In practice, the masking by the white particles may be imperfect so that there may be some small absorption of light by a particle that ideally would be completely masked. Such contamination typically reduces both the lightness and the chroma of the color being rendered. In the instance of FIG. 4B, the presence of the light-absorbing particles often causes the overall image to look darker due to imperfect scattering of the reflective particles. This is particularly problematic for green hues because the human eye is very sensitive to different shades of green, whereas different shades of red are not as noticeable. In some embodiments, this can be corrected with the inclusion of additional particles with different steric or charge characteristics, e.g., a green scattering particle, however adding additional particles complicates the drive scheme and may require a wider range of driving voltages. Obviously, in the electrophoretic media described herein, such color contamination should be minimized to the point that the colors formed are commensurate with an industry standard for color rendition.

Waveforms for driving four-particle electrophoretic media have been described previously. Waveforms for driving color electrophoretic displays having four particles are described in U.S. Pat. Nos. 9,921,451, 9,812,073, and 11,640,803, all of which are incorporated by reference herein. Most commercial electrophoretic displays use amorphous silicon based thin-film transistors (TFTs) in the construction of active-matrix backplanes (260) because of the wider availability of fabrication facilities and the costs of the various starting materials. Amorphous silicon thin-film transistors may become unstable when supplied gate voltages that would allow switching of voltages higher than about +/−15V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451. In alternative embodiments, metal oxide semiconductors may be incorporated into thin film transistors for active-matrix backplanes (260), including IGZO, i.e., as described in U.S. Pat. No. 11,776,496, which is incorporated by reference in its entirety.

In the multi-particle systems described above, it is preferable to have fast updates for displaying moving text, such as scrolling, page flips, pinch-zoom, or even short videos. Consumers expect to be able to navigate black and white text with speeds approximating LCD displays, i.e., at least 20 image updates per second. In state-of-the-art devices this high speed is typically achieved by changing driving modes from a first mode having a large number of color states, e.g., gray tones, to a driving mode having only two, typically black and white color states. This driving mode is typically referred to as A2 and, when using only black and white particles, can operate as a true 1-bit system. In systems including more than two particles the A2 state is approximate because driving all of the particles of one charge to the viewing surface will result in mixed colors. However, because of the limited time that a pixel is in each color state when in the A2 mode, variances in color level (a.k.a. optical quality) typically go unnoticed.

To correct for the color variation, a display (portions of the display) being driven in A2 mode undergoes a transitional update when the A2 driving is finished, restoring most of the original gray tones or colors. See, e.g., U.S. Patent Publication No. 2024/0078981. However, during A2 driving the updates are so fast that there is not time for each update to use a waveform long enough to achieve DC balance. Accordingly, the remnant voltage at a given pixel electrode can build up quite quickly in A2 mode, which causes image errors, such as color drift and ghosting. In some cases, the remnant voltage buildup can be large enough to damage the module by causing current flow through the thin film transistors when the transistor gate is not energized. This discharge condition typically results in a pixel electrode that can no longer be controlled by the controller. To avoid such damage, state of the art devices make judicious use of a combination of “top off” pulses and refresh pulses to both improve the color state and remove excess charge build up. See, e.g., U.S. Pat. No. 11,145,261.

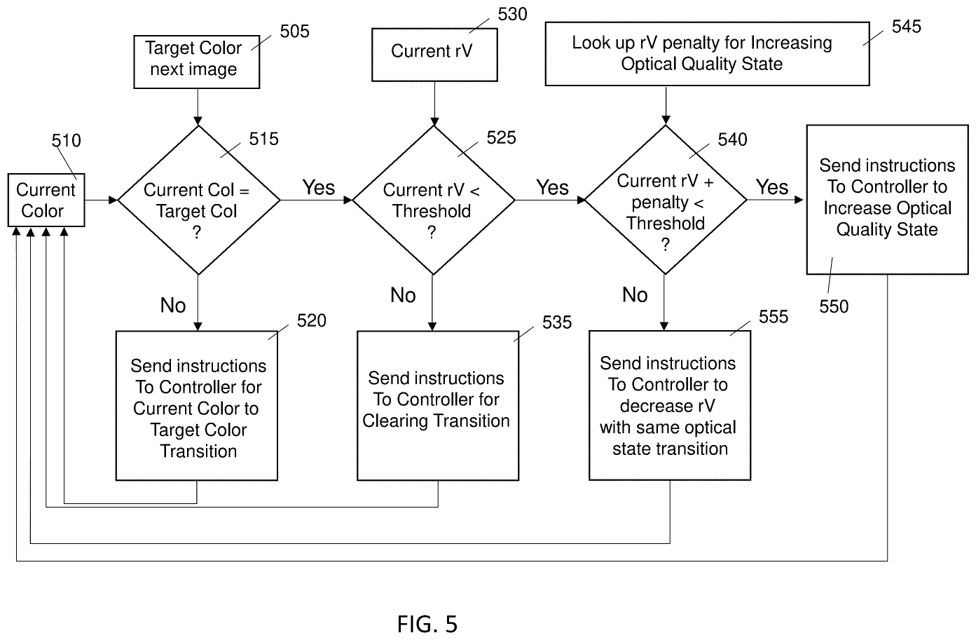

In contrast to the state of the art, the methods of the invention actively manage the remnant voltage and take advantage of each “same color” transition, i.e., black-to-black or white-to-white to both improve the optical quality of the color state and to decrease the remnant voltage buildup. Additionally, the methods of the invention limit the size of the jumps in remnant voltage by only shifting one optical quality state at a time. As shown in FIG. 5, starting from identified current (510) and target (505) states, the value of the current (510) and target (505) states are compared and identified to be the same or different (515). If the current (510) and target (505) colors are different, i.e., due to a color transition for the image pixel between a first and a second image, then the controller is sent waveform instructions (520) as would happen in a typical image update. Optionally, in the instance that the current (510) and target (505) states are the same color state, a calculated remnant voltage is determined (530) for the current (510) state, and the calculated remnant voltage is compared to a remnant voltage threshold (525). For this option, if the calculated remnant voltage is determined to be in excess of the remnant voltage threshold, the controller is instructed to implement a clearing transition (535), which may be, for example, a driving waveform sufficient to have the electrophoretic medium driven to each electrode and then returned to the current (510) state.

In the instance that the calculated remnant voltage is smaller than remnant voltage threshold requiring the controller to be instructed to implement a clearing transition (535) or in the option that the feature of (535) is not used, a look-up-table is accessed to determine a remnant voltage penalty for the current (510) state to increase its optical quality state (545). The sum of the remnant voltage penalty (545) and the current remnant voltage (530) becomes a projected remnant voltage, which is compared to the remnant voltage threshold at (540) in order to determine whether increasing the optical quality of the current (510) state will result in a remnant voltage that is still less than the remnant voltage threshold. If yes, the controller is sent instructions to increase the optical quality state by sending suitable waveforms as accessed from a look up table indexed to color state and remnant voltage. If no, that is the sum of the remnant voltage penalty (545) and the current remnant voltage (530) exceeds the remnant voltage threshold, the controller is sent instructions to decrease the remnant voltage without changing the optical state (555) by sending suitable waveforms as accessed from a look up table indexed to color state and remnant voltage. The resulting output of the flow chart in FIG. 5 is a new color state, which may be different from the target (505) state, but which becomes the new current (510) state. The process repeats until the color state is stable, with no calculated remnant voltage, and the highest possible optical state or until the display leaves the A2 mode, at which point a transitional mode (not shown) may be used to correct the color states of the various display pixels.

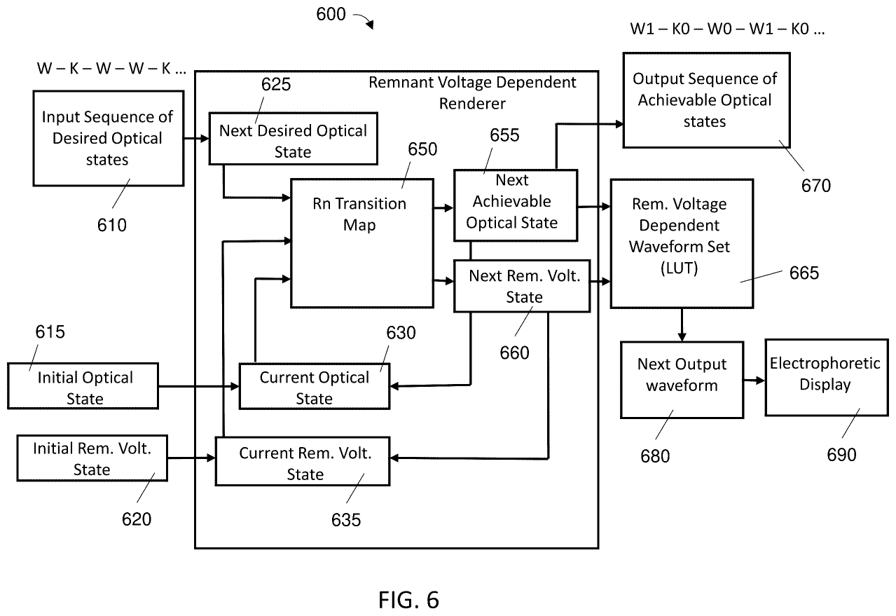

Importantly, the invention makes use of a remnant voltage dependent renderer (600) and a remnant voltage dependent waveform Look-Up-Table (LUT) (665) to enable fast and interruptible waveform updates to an electrophoretic display while maintaining a bounded remnant voltage. As shown in FIG. 6, the remnant voltage dependent renderer (600) achieves this by using a specially designed state transition map (650) containing intermediate optical quality states for each color, tuned interruptible waveforms going from one quality state to another and tuned discharge waveforms for reducing built-up remnant voltage without changing the quality state. This process is typically implemented for each display pixel, however larger areas of a display (patches), such as backgrounds or margins may be simultaneously addressed. The remnant voltage dependent renderer (600) computes the next achievable optical state (closest to the next desired optical state), and the next resulting remnant voltage state; which are then used as inputs to look up a corresponding waveform to be applied from the remnant voltage dependent waveform Look-Up-Table (LUT) (665).

The state transition map (650) implements remnant voltage dependent rendering to compute the next achievable optical quality state that is closest to the next desired optical state (target state) based on the current optical and remnant voltage state of the display (current state). An implementation of the state transition map may include instructions such as the below pseudo code, which is executed by a processor:

State Transition Map (denoted as a function f )

Inputs:

| | |
|---|---|
| 1. | Next Desired Color State: Denoted with symbol T |
| 2. | Current Color State: Denoted with symbol Cₙ |
| 3. | Current (Optical) Quality State: Denoted with symbol Xₙ |
| 4. | Current (Remnant) Voltage State: Denoted with symbol Rₙ |

Outputs:

| | |
|---|---|
| 1. | Next Color State: Cₙ₊₁ |
| 2. | Next Quality State: Xₙ₊₁ |
| 3. | Next Voltage State: Rₙ₊₁ |

External Parameters:

| | |
|---|---|
| 1. | Bound on voltage state: B |
| 2. | Look up table for remnant voltage changes resulting due to the waveforms: |

Denoted by function S(Xₙ₊₁−Xₙ, Cₙ, Cₙ₊₁)
Algorithm defining the State Transition Map:
function f(Cₙ, Xₙ, Rₙ, T){

| | |
|---|---|
| Cₙ₊₁ = T | // next color state is always guaranteed to be the desired color state |

if T == Cₙ {

```
  // if the desired color is the same as the current color
  // improve the quality state if possible, else improve the voltage state
  if S(1, Cₙ, T) − B < Rₙ < B − S(1, Cₙ, T){
    Xₙ₊₁ = Xₙ+1; Rₙ₊₁ = Rₙ + S(1, Cₙ, T) }
  else { Xₙ₊₁ = Xₙ; Rₙ₊₁ = min(Rₙ + S(0, Cₙ, T), 0); }
```

```
  }
  else {
```

```
  // reset the quality state to its lowest
  Xₙ₊₁ = 0; Rₙ₊₁ = Rₙ + S(0, Cₙ, T)
```

```
  }
  return Cₙ₊₁, Xₙ₊₁, Rₙ₊₁
}
Usage in a remnant voltage dependent renderer:
Initialize Cₙ, Xₙ, Rₙ to their initial values
while new T in processing queue: {
```

get new T from queue
// compute the state transition to apply
Cₙ₊₁, Xₙ₊₁, Rₙ₊₁ = f(Cₙ, Xₙ, Rₙ, T)
// look up the waveform Wₙ to apply to display from a R2 set LUT
Wₙ = Waveform_LUT( [Cₙ,Xₙ, Rₙ], [T,Xₙ₊₁, Rₙ₊₁] )
// Update Current state values in memory
Cₙ = Cₙ₊₁; Xₙ = Xₙ₊₁; Rₙ = Rₙ₊₁

}

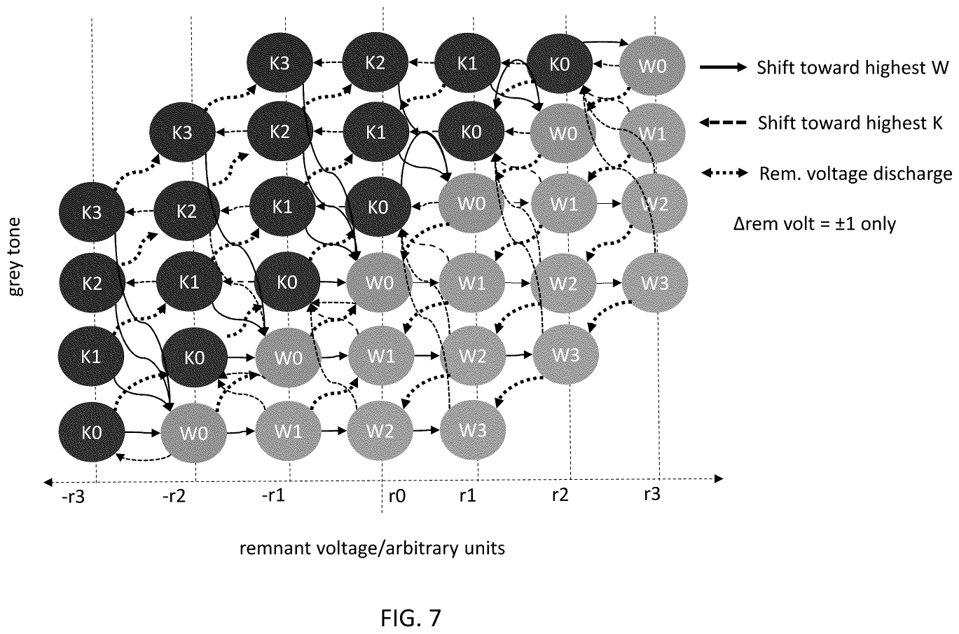

A state transition diagram illustrating the operation of the state transition map algorithm (above) for black to white and white to black transitions in the A2 mode for a four particle WCMY system is shown in FIG. 7. The state transition diagram shows the available optical quality and remnant voltage state transitions of the display pixels within the bounded remnant voltage state space. The state space representation is generalizable to:

$${Y}_{n} = \{ W , K \} \times \{ 0 , 1 , 2 , … , Q \} \times \{ - {r}_{k} , … - {r}_{2} , - {r}_{1} , 0 , {r}_{1} , {r}_{2} , … , {r}_{k} \}$$

where {W, K} denotes the color states (Cₙ), {0, 1, 2, . . . , [symbol] } denotes the quality states (Xₙ), and {−rₖ, . . . −r₂, −r₁, 0, r₁, r₂, . . . , rₖ} denotes the remnant voltage states (Rₙ). It is not a requirement that the state space representation have only two color states, and the state transition diagram of FIG. 7 is generalizable to more dimensions by using more color states. In FIG. 7, representing A2 mode containing Black (K) and White (W) color states, with Q number of quality states for each color, and (2k+1) remnant voltage states, the remnant voltage state tracking is bounded between −B to B volts, which may be an arbitrary number or determined by physical parameters, such as the breakdown voltage for the transistors in the active matrix backplane.

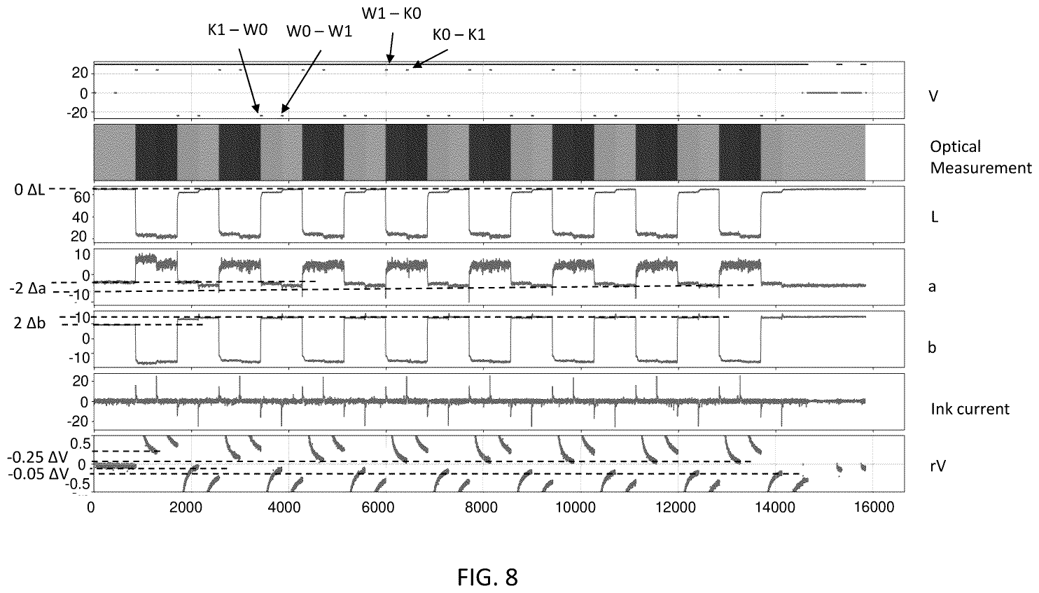

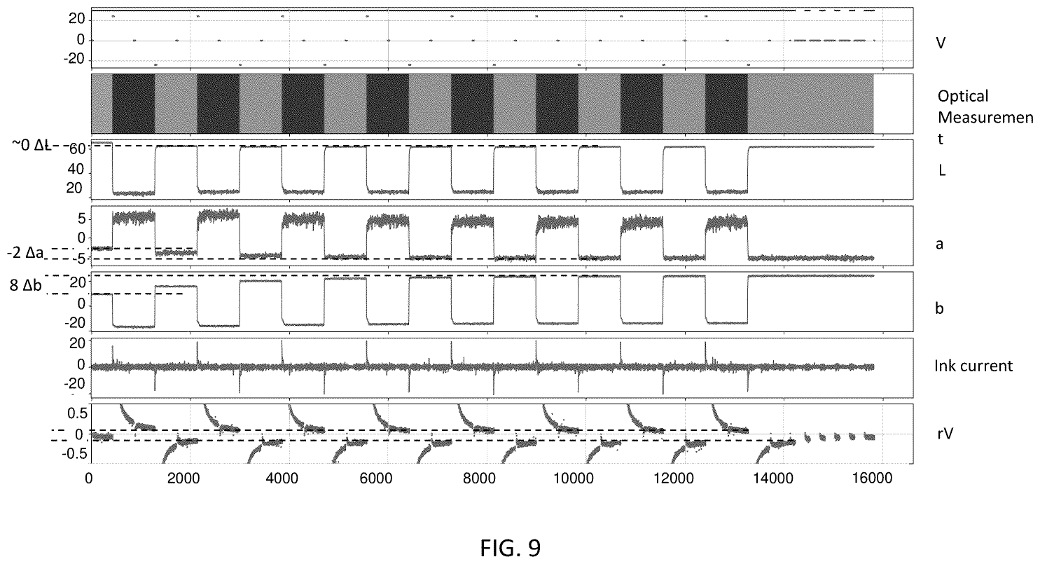

Exemplary test waveforms with (FIG. 8) and without (FIG. 9) active remnant voltage management methods, as illustrated in FIGS. 5-7 are shown in FIGS. 8 and 9. For both FIGS. 8 and 9, a WCMY four particle system (a.k.a. ACeP®, a.k.a. Gallery™ 3) is repeatedly driven between the black and white optical states with a repeat cycle of about 0.5 seconds. Using the methods of the invention, i.e., FIG. 8, the transitions involve two optical quality states of white and two optical quality states of black, i.e., W0, W1, K0, and K1, with the transitions going from W1 to K0 and from K1 to W0, which represent smaller accumulated remnant voltage (area under swooshes to zero in bottom row, marked “rV). As shown in FIG. 9, state-of-the-art driving between black to white can lead to greater remnant voltage buildup, which in a WCMY four particle system manifests itself as color drift in the b* measurement. (The Δb* drift in FIG. 8 is only about 2, whereas in FIG. 9 the Δb* drift is nearly 8.) Additionally, in FIG. 9, there is some a* drift whereas there is virtually none in FIG. 8. When such features are present in a display showing images, this drift appears as artifacts or ghosts. The color drift can be particularly noticeable when an image pixel is part of a dithered object, thus the overall effect can be a true shift of a large object rather than an image pixel that seems out of place. Because of human perception, dithering errors in foods and skin colors are particularly offensive.

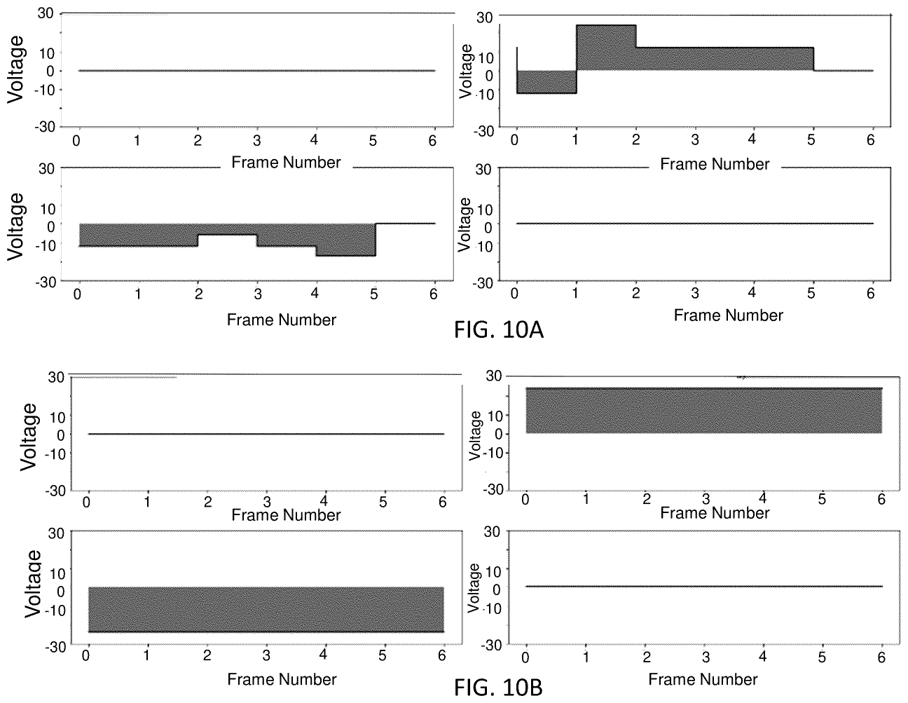

Additional benefits are achieved by tuning the color transition waveforms for faster implementation and reduced remnant voltage. The modifications also allow for interruption of image updates (truncation of waveforms) without huge swings in remnant voltage. As a general form, we divide each color state (N) into Q number of quality states. (In the instance of FIGS. 7, N=2 and Q=3.) Q×N scan-frame waveforms for driving the state of the display sequentially from one quality state to another are then created (improving the quality with each N frame section). (A scan frame is the time required to update each pixel electrode in an active matrix in a row-by-row fashion.) Exemplary tuned waveforms for optical quality improvements to black and to white are shown in FIG. 10A, however other shapes of tuned waveforms are possible. (White to black is upper righthand panel and black to white is the lower lefthand panel.) The first section of the waveform is tuned to change the color state coming from another color and for achieving the lowest optical quality state of the target color (allowing for a quick update/refresh rate of the display). The subsequent Q−1 sections of N frames of the tuned waveform are each selected to improve the quality state if the opportunity presents itself in a rendering sequence.

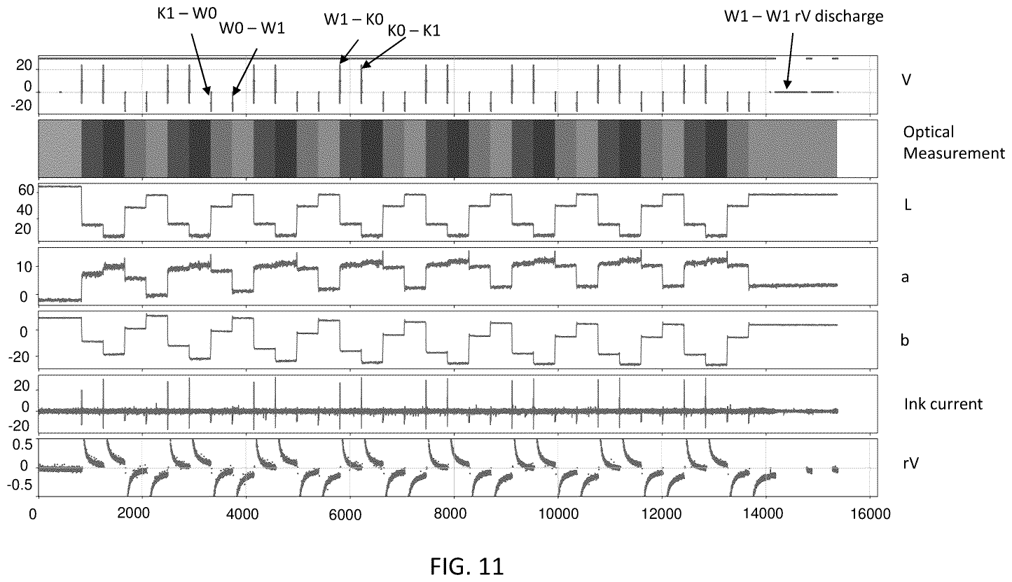

For example, FIG. 10A shows an N=6 frame waveform tuned for the A2 mode containing black and white color states. The designed waveform uses Q=4 and the remaining Q−1 sections each use the waveforms shown in FIG. 10B. In 10B, the top-right and bottom-left quadrants of the figure on the right show the black to black, and white to white quality improving waveforms respectively. The top-left and bottom-right quadrants show an all 0-waveform that is used as discharge waveforms that maintain the same quality state for a given color, but drive the remnant voltage state towards 0 (See FIG. 11). In general, it is also possible to tune non-zero waveforms as discharge waveforms maintaining the optical (quality and color state) but driving the remnant voltage state towards 0, at a faster rate, however such architecture requires advanced power management (PMIC) chips that are currently quite expensive. A simulation of a black-white repeat cycle similar to FIGS. 8 and 9, but implementing the tuned waveforms of FIG. 10A is shown in FIG. 11.

At fast update rates, optical states of a pixel or patch of pixels can be degraded due to the use of a short waveform. Optical states that only appear as a fast transient and then change to some other optical state however need not be achieved at their highest quality due to the lower perceptibility of such fast changes. However, degraded quality of optical states that linger over multiple frames without changing are more perceptible to the viewer if left unaddressed. The use of interruptible waveforms that can achieve an intermediate optical states in a short update time with a quality tradeoff and then continue to improve the optical state quality over multiple update frames, allow for the use of fast update rates without affecting the overall perceptible quality.

### Example

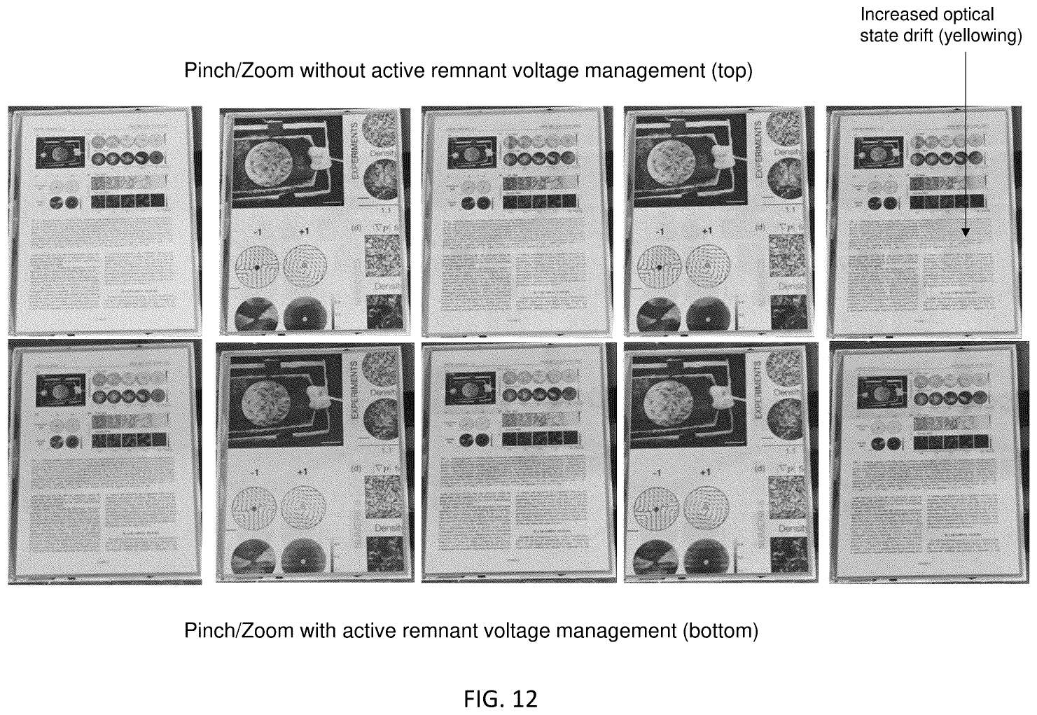

The methods of the invention have been implemented in a 10″ diagonal Gallery™3 electrophoretic display incorporating an IGZO active-matrix backplane. The same pinch-zoom image sequence was executed in normal A2 mode (top row of FIG. 12) and using the active remnant voltage management methods of the invention (bottom row of FIG. 12). FIG. 12 (top row) shows the evolution (degradation) of optical states over two cycles of a pinch and zoom animation loop (simply using short waveforms to achieve a 12 frames per second (12 fps) update rate). FIG. 12 (bottom row) shows the evolution (improvement) of optical states over the same pinch and zoom animation loop (at 12 fps) using the interruptible, remnant voltage dependent waveform design and rendering of the present invention. It is clear that even after this short sequence, there is noticeably less yellowing in the bottom sequence of FIG. 12, indicative of less remnant voltage build-up and less color drift.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A method for regulating remnant voltage in an electrophoretic display comprising a layer of electrophoretic media disposed between a light-transmissive electrode and a plurality of drive electrodes and a controller coupled to the plurality of drive electrodes, the method comprising:
determining for each display pixel in the electrophoretic display whether that display pixel has a same color state for a first image and a second image;
sending instructions to the controller to provide waveforms corresponding to a transition from the color state of the first image to the color state of the second image for each display pixel that does not have the same color state for the first image and the second image;
determining a calculated remnant voltage for each display pixel having the same color state for the first image and the second image;
determining a projected remnant voltage for each display pixel having the same color state for the first image and the second image when that display pixel receives instructions to increase optical quality state;
comparing the projected remnant voltage for each display pixel having the same color state for the first image and the second image to a remnant voltage threshold;
sending instructions to the controller to provide waveforms causing an increase in optical quality state for each display pixel having the same color state for the first image and the second image and having a projected remnant voltage less than the remnant voltage threshold; and
sending instructions to the controller to provide waveforms causing a decrease in remnant voltage for each display pixel having the same color state for the first image and the second image and having a projected remnant voltage greater than or equal to the remnant voltage threshold.

2. The method of claim 1, further comprising comparing the calculated remnant voltage to the remnant voltage threshold and sending instructions to the controller to provide waveforms causing a clearing transition for each display pixel having a calculated remnant voltage greater than or equal to the remnant voltage threshold.

3. The method of claim 1, wherein the determining and comparing steps are completed with a processor coupled to memory and the controller.

4. The method of claim 3, wherein the memory comprises a look up table of waveforms indexed by color state transition and remnant voltage.

5. The method of claim 1, wherein each display pixel corresponds to one of the plurality of drive electrodes.

6. The method of claim 1, wherein the electrophoretic display comprises an electrophoretic medium including electrically charged particles dispersed in a fluid and confined within a plurality of capsules or microcells.

7. The method of claim 6, wherein the electrophoretic medium includes four different types of electrically charged particles, and at least two of the types of electrically charged particles have opposite polarities.

8. The method of claim 7, wherein six primary colors can be formed at each pixel electrode of the electrophoretic display.

9. The method of claim 1, wherein the electrophoretic display includes a color filter array and each display pixel includes multiple drive electrodes.

10. The method of claim 9, wherein the color filter array comprises a plurality of differently colored filters and individual differently colored filters are indexed to individual drive electrodes.

11. The method of claim 1, wherein the waveforms causing an increase in optical quality state are tuned to reduce remnant voltage increase while increasing optical quality state.

12. The method of claim 1, wherein the waveforms causing a decrease in remnant voltage are tuned to maintain the optical quality state.

13. The method of claim 1, wherein the first image and the second image are displayed on the electrophoretic display within 100 ms, preferably within 50 ms.

14. The method of claim 1, wherein the plurality of drive electrodes are arranged in an array of pixel electrodes and each pixel electrode is coupled to a thin-film transistor (TFT), the TFT preferably comprising a metal oxide semiconductor, most preferably IGZO.

15. An electrophoretic display configured to actively manage remnant voltage during updates, comprising:
a light-transmissive electrode;
a plurality of drive electrodes;
a layer of electrophoretic media disposed between the light-transmissive electrode and the plurality of drive electrodes;
a controller coupled to the plurality of drive electrodes; and
a processor, the processor configured to:
determine for each display pixel in the electrophoretic display whether that display pixel has a same color state for a first image and a second image,
send instructions to the controller to provide waveforms corresponding to a transition from the color state of the first image to the color state of the second image for each display pixel that does not have the same color state for the first image and the second image,
determine a calculated remnant voltage for each display pixel having the same color state for the first image and the second image,
determine a projected remnant voltage for each display pixel having the same color state for the first image and the second image when that display pixel receives instructions to increase optical quality state,
compare the projected remnant voltage for each display pixel having the same color state for the first image and the second image to a remnant voltage threshold,
send instructions to the controller to provide waveforms causing an increase in optical quality state for each display pixel having the same color state for the first image and the second image and having a projected remnant voltage less than the remnant voltage threshold, and
send instructions to the controller to provide waveforms causing a decrease in remnant voltage for each display pixel having the same color state for the first image and the second image and having a projected remnant voltage greater than or equal to the remnant voltage threshold.

16. The electrophoretic display of claim 15, wherein the processor is further configured to compare the calculated remnant voltage to the remnant voltage threshold and send instructions to the controller to provide waveforms causing a clearing transition for each display pixel having a calculated remnant voltage greater than or equal to the remnant voltage threshold.

17. The electrophoretic display of claim 15, wherein each display pixel corresponds to one of the plurality of drive electrodes.

18. The electrophoretic display of claim 15, wherein the electrophoretic medium includes electrically charged particles dispersed in a fluid and confined within a plurality of capsules or microcells.

19. The electrophoretic display of claim 18, wherein the electrophoretic medium includes four different types of electrically charged particles, and at least two of the types of electrically charged particles have opposite polarities.

20. The electrophoretic display of claim 19, wherein six primary colors can be formed at each pixel electrode of the electrophoretic display.

21. The electrophoretic display of claim 15, wherein the electrophoretic display includes a color filter array and each display pixel includes multiple drive electrodes.

22. The electrophoretic display of claim 21, wherein the color filter array comprises a plurality of differently colored filters and individual differently colored filters are indexed to individual drive electrodes.
